(19) United States
(12) Patent Application Publication
(10) Pub. No.: US 2006/0236913 A1
(43) Pub. Date: Oct. 26, 2006

(54) Medical devices

(76) Inventor: Anthony Wills, London (GB)

Correspondence Address: COZEN O' CONNOR , P.C., 1900 MARKET STREET, PHILADELPHIA, PA, 19103, US

(21) Appl. No.: 10/560,955

(22) PCT Filed: Jun. 18, 2004
(86) PCT No.: PCT/GB04/02634

§ 371 Date: May 22, 2006

(30) Foreign Application Priority Data
Jun. 19, 2003 (GB) 0314247.8
Jun. 26, 2003 (GB) 0314920.0
Sep. 19, 2003 (GB) 0321911.0

(51) Int. Cl. G01D 21/00

(52) U.S. Cl. 116/206

(57) ABSTRACT

A medical device including a latent marking which becomes visible upon exposure to ambient conditions.

This invention concerns improvements in or relating to medical devices and in particular, but not exclusively to medical devices intended for single usage only and to containers of pharmaceutical or non-pharmaceutical preparations.

Any medical establishment, for example a hospital, should be the focus for scrupulous hygiene with a view to minimising the risk of infection especially in patients following surgery when they are most vulnerable. The relatively and worryingly high incidence of for example MRSA in hospitals is of great concern since treatment is exceedingly difficult and in some instances the infection results in fatality.

In the practice of modern medicine, many devices that are widely available are of the single use category, namely that once used they should be discarded to ensure destruction before nominally forbidden further usage.

Devices such as cannulas, catheters and other relatively minor medical accoutrements are usually supplied in a sterilised packaging and when extracted they become subject to the rigours of the ambient atmosphere and more importantly to the specific medical procedure for which they are designed. The spread of infection can occur when devices of this kind are used more than the prescribed single occasion. This abuse of single use devices is to be deprecated, but some measures have been applied with a view to preventing multiple use. For example, in the case of hypodermic needles frangible parts are employed to the extent that any attempted further use effects breakage rendering the needle incapable of deployment. Equally in spare parts surgery, for example hip prostheses, some manufacturers produce the relevant part in a material which is not susceptible of sterilisation, and any attempt to autoclave the part results in its disintegration. Clearly an approach of that kind is acceptable for spare parts, but for conventional medical devices of relatively minor value it would be unnecessarily burdensome to produce them from sophisticated materials.

There are considerable financial pressures placed upon medical personnel to re-use single-use medical devices as the savings in expenditure can be significant, but the consequences of inadequate sterilisation can be catastrophic.

It is also medically important to be able to prevent the use of prescription and non prescription medicines and formulations when their sterility has been compromised, when their expiry date has been exceeded or to prevent cross contamination of medicines between patients.

Many tablets are packaged in sterile packaging, for example, foil or plastics materials. In order to remove the tablet from the packaging it is pushed towards the foil cover thereby breaking a seal. By examining the foil packaging it is possible to immediately determine whether the medicine has been either tampered with and/or its sterile packaging compromised. However, other medicines may be formulated as liquids, suspensions, pastes which cannot be packaged in this way. Such medicines may also only be medically effective or safe for administration for a fixed period of time after their packaging has been opened. This is particularly important in paediatric formulations and preparations, for example baby or infant milk preparations or liquid paediatric medicines.

It is therefore also desirable to have a means for determining the expiry date of a medicine or formulation following its first use and/or for providing an indication of the sterility of the medicine.

An object of the present invention is to provide a medical device having means for informing the user of the status of the device in terms of further usage.

According to a first aspect of the invention there is provided a medical device including a latent marling which becomes visible following exposure of the device to ambient conditions.

The present invention may prevent re-use of a medical device in the following circumstances: use of a medical device accidentally contaminated by damaged packaging; deliberate re-use of a medical device contaminated by previous use; deliberate re-use of an item incompletely or inappropriately re-sterilised and re-packaged; use of a medical device having its sterile packaging disrupted; or use of a medical device having contents which are no longer safe for administration or medically effective.

The medical device may be any instrument, apparatus, appliance, material or other article, whether used alone or in combination, including the software necessary for its proper application intended by the manufacturer to be used for animals (and human) for the purpose of: diagnosis, prevention, monitoring, treatment or alleviation of disease; diagnosis, monitoring, treatment, alleviation of or compensation for an injury or handicap; investigation, replacement or modification of the anatomy or of a physiological process; control of conception; and which does not achieve its principal intended action in or on the human body by pharmacological, immunological or metabolic means, but which may be assisted in its function by such means, and includes any article which, whilst not being a device as described above is intended specifically by its manufacturer to be used together with such a device to enable it to be used in accordance with the use of the device intended by the manufacturer.

The medical device may therefore be of any description for use in any medical procedures requiring contact with a patient, for example a cannula, a catheter, speculum, a spatula, even face masks and protective gloves etc. most of which are initially encased within and supplied in sterile packaging.

The medical device may comprise a cardiovascular device (for example an angiography catheter, a blood pressure cuff, a cardiac ablation, a catheter, a cardiac guidewire, a compressible limb sleeve, an electrophysiology recording catheter, an intra aortic balloon catheter, a needle, a percutaneous transluminal coronary angioplasty (PTCA) catheter, a percutaneous transluminal angioplasty (PTA) catheter, a syringe or a trocar), a respiratory device, (for example, a breathing mouthpiece, an endotracheal tube, a mask, an oral or nasal catheter, a respiratory therapy and anaesthesia breathing circuit or Tracheobronchial suction catheter), a gastroenterology/urology device (for example a biliary sphincterotome, a biopsy neede, an endoscopic guidewire, an endoscopic stapler, an extraction balloon/basket, a non-electric biopsy forcep, a trocar, a urethral catheter, a nephrology device, and haemodialysis or blood tubing), an obstetrics/gynaecological device (for example a laparoscopic dissector, a laparoscopic grasper, a laparoscopic scissor or trocar), an orthopaedic device (such as an arthroscopy instrument, a carpel tunnel blade, drill bits, an external fixation device, a flexible reamer/drill, a saw blade and a surgical drill), a surgery device (such as biopsy forceps, a biopsy needle, a burr, an electrosurgical electrode/handle/pencil, an endoscope, an endoscopic blade, an endoscopic guidewire, an endoscopic stapler, a fascia holder, a laparoscope, a laser fiber delivery system, a scissor tip, a removable insert, a surgical cutting accessory and a Trocar), or other medical devices (such as a stapler, a glucometer lancet, a keratome blade, an operating room (OR) drape, a phacoemulsification needle, an OR gown, a Sharps container, a syringe, a piston, an infusion pump, an implanted, syringe or irrigating).

Finally, a medical device in accordance with the present invention also includes containers of prescription and non-prescription pharmaceutical preparations such as bottles, tubes and other dispensers, oral dosage form (i.e. tablet) packs, for example, blister packs.

Such pharmaceutical preparations may comprise opthamological preparations for topical application (e.g. eye drops), dermatological preparations, cough mixtures, anti-reflux and other gastro-intestinal tract preparations, liquid antibiotics, other liquid preparations, in particular those intended for paediatric use, any other preparations intended for or suitable for administration to paediatrics, including infant food and milk formulations, and vitamin preparations.

These preparations may contain active ingredients that could be potentially be harmful if taken or otherwise absorbed in excess (e.g. steroids in dermatological preparations) or whose activity might become altered and/or degraded in time (e.g. antibiotics) or which might transmit infection if left open to the environment and/or used by more than once person (e.g. eye drops).

The marking is a latent marking which becomes visible following exposure of the device to ambient conditions and/or during or following first usage of the device. The marking may be in the form of an etching or other marking e.g. printing of a dye, ink or other chemical compound on the device per se which may be obscured by a layer prior to exposure to ambient conditions. The layer may be an opaque layer which, following exposure of the device to ambient conditions changes to clear or colourless in order to reveal the etching or other marking.

In the alternative, the marking may be included on a label irremovably attached to a part of the medical device. The label may contain a latent marking which appears, for example to reveal a message or symbol, following exposure of the device to ambient conditions. The marking may appear due to a change from clear or transparent to opaque or may be revealed due to a change in an opaque coating to clear or transparent.

Alternatively, the latent marking may be printed (using for example invisible ink or dye) directly onto the device or may even be a part of the device, e.g. the hub of a syringe, and appear following exposure of the device to ambient conditions.

In a further embodiment, the marking may be initially coloured and, upon exposure to ambient conditions, change to a contrasting or different colour e.g. from green to red. In this case, the latent marking is the contrasting or different colour marking.

The marking may be provided with a sealing strip or film to protect it and prevent or assist in preventing premature damage that would otherwise cause degradation by wear. The latent marking may also be designed to withstand any attempt to recycle the medical device, namely the latent marking will survive throughout the period of use of the device or at the end of the period of use and thereafter.

The label is conveniently provided with an adhesive of a strength sufficient to withstand handling and exposure to any physical abuse which may be designed to remove the latent marking. The adhesive should therefore also provide a secure bond with the medical device to which the label is attached. Modified acrylic adhesive, such as that available from 3M comprises a suitable adhesive for use in the present invention

The marking may be adapted to become visible upon exposure to ambient conditions. The ambient conditions include light (visible, UV, IR), the atmosphere, gases in the air and /or temperature. The marking of the medical device may therefore be adapted to become visible upon exposure to air or light. Exposure of the marking to air or light may trigger the irreversible change of appearance of the marking. Exposure of the marking to air may cause a change in the pH of a chemical forming part of the marking causing the marking to become visible.

The marking may be designed to be gas, light, pH or temperature sensitive in terms of the marking becoming visible within a predetermined time frame following exposure to ambient conditions, for example exposure to the atmosphere once it has been removed from its packaging.

The marking may have indicia and/or be symbolic and/or may be in the form of wording that provides a suitable warning against further usage. The symbol used for warning the user of the spent status of the medical device may be conventional, e.g. a skull and cross bones or the biohazard logo, and the wording may be by way of information that the current period of use should be final, for example “expired- return to pharmacy”, “time to dispose of safely” or “do not use”.

The symbol or warning may comprise a single colour or may use several colours. The marking may be a colour or colours which appears or changes during or following exposure of the device to ambient conditions or first usage or opening of the device. For example, the marking may be provided by a dye or light-sensitive chemical that changes colour upon or during exposure to ambient conditions such as air, light or temperature. Thus, the marking may comprise dyes or chemicals applied in such manner as to yield a warning message in the visible spectrum following exposure.

In one embodiment, the marking is invisible to the naked eye before exposure of the device to ambient conditions or before the first use of the device. If the marking is visible before exposure of the device to ambient conditions or its first usage, then the change induced in the marking following first usage should be significant so that it is obvious to the user that the device has been used.

The marking may become visible after a pre-defined period of time of exposure to ambient conditions. The change in the marking may occur rapidly at the end-point of this period of time rather than slowly developing over time, in order to provide a firm indication of the expiry of the device. The delay of the onset of colour change can be varied, typically in the range of 3 minutes to 2 weeks, however the marking may develop over a period of time ranging from a defined number of seconds, minutes, hours, weeks or months to indicate expiry. For example, the marking may become visible immediately in order to indicate that the device should not be re-used.

The marking may conveniently be made with dyes or suitable chemicals having the requisite sensitivity as indicated supra. Suitable chemical systems which become visible or change colour or visibility following exposure to ambient conditions may be based on a change in pH, oxidation, solvent evaporation, absorption of moisture, absorption of gases or may use photochromic materials. The chemical reaction initiated may be irreversible, preventing subsequent tampering with the marking. The marking used may be selected according to its suitability for incorporation onto a particular medical device and the time scale on which the marking is required to develop. For example, intravenous drips may need to be changed every 3 days. A hypodermic needle marking might be required to change within two minutes of exposure. A topical cream or skin application might be required to be useable for up to three weeks. The latent marking is therefore selected appropriately according to the medical device to be used or its contents.

In one embodiment, the marking changes in visibility owing to evaporation of a volatile material (for example an acid or base) present in the marking which causes a change in pH. The colour change or appearance may be irreversible once all the volatile material has evaporated. For example, a pink to colourless change would occur upon evaporation of a volatile acid (such as acetic acid) or base (such as ammonia) from a marking comprising phenolphthalein. This is a medium strength colour change having an optical density of 1.4 to 2.0 and takes about 20 mins.

Alternatively, flow of a pH modifying material through a membrane which is present in the area containing the marking may result in colour appearance or change. The delay period before the colour change or appearance occurs may be adjusted by using materials of differing volatility or by using membranes with varying transmission rates.

Exposure to oxygen in the open atmosphere may cause a dye to be oxidised, thereby inducing a change in the visibility of the mark e.g. a colour change. The delay period before the change occurs maybe adjusted by adding a reducing agent or inhibitor to the dye which is preferentially oxidised before the dye is then oxidised. The concentration of the reducing agent may be varied to vary the time delay.

Reduced methyl green is colourless. When exposed to air, the reduced methyl green is oxidised to give methyl green, which is a bluish green colour. This is a strong colour change having an optical density of greater than 2 and typically takes 4-5 mins. A further example is the use of Indigo to result in a light yellow to dark blue colour change following exposure to air. Reduced Indigo is yellow and oxidises on exposure to air to give an intense blue colour. This is a strong colour change also having an optical density greater than 2 and takes 2-3 mins.

Similarly, other oxidation sensitive Vat dyes may be used. Vat dyes are a class of textile dyes used to dye cellulose fabric. The Vat dyes are applied in a reduced, soluble form and then oxidize to the insoluble pigment. Common Vat dyes are quinonic dyes and particularly common are anthraquinones and indigoids. VAT dyes include the natural dyestuff, indigo, and the artificial dyes called by the trade names, indanthrene, and flavanthrene.

Alternatively, a change in the marking could be induced by evaporation of a solvent (for example an alcohol e.g. ethanol, methanol, butanol, propanol), causing a dye to precipitate out of solution. The time delay before the change occurs may be altered by varying the concentration and/or volatility of the solvent used.

Moisture in the open atmosphere may be absorbed into the marking thereby inducing the change. An example is a blue to colourless change using cobalt chloride. Cobalt chloride embedded in a polymer matrix can absorb moisture from the open atmosphere when exposed, to give colourless Co(H₂O)₆²⁺. This produces a very pronounced colour change having an optical density of over 2 after about 30 minutes.

Gases such as CO₂ maybe absorbed from the open atmosphere and induce a change in the marking. An example is a pink to colourless change using phenolphthalein and guanine. Phenolphthalein and guanine solution has a pink colour. When a paper sample carrying phenolphthalein and guanine is exposed to air, guanine absorbs carbon dioxide in the air, to give guanine carbonate, rendering the system colourless. This system gives a medium strength colour change having an optical density of 1.4 to 2.0 and takes about 20 mins.

Photochromic chemicals and dyes used in the photographic industry such as silver salts may also be suitable for use in the present invention but are required to be non-toxic in the light of their intended usage (or sealed from contact with bodily fluids).

Generally the latent marking, as with the medical device to which it is applied, must not compromise the clinical condition or the safety of patients or of other persons during the lifetime of the device in question. Further, the latent marking must be compatible with biological tissues, cells and body fluids, taking account of the intended purpose of the device in question, or at least sealed therefrom.

The medical device of the present invention may be provided with two differing markings. One marking may change from a colourless state to a coloured state to provide a written or symbolic warning of the exposure of the device to ambient conditions. A second marking present on the same device may at the same time change from a highly coloured state to a colourless state. The device may therefore have a dual marking which partially emerges and partially fades to form the final warning following exposure to ambient conditions. Alternatively, the second marking may change from a highly coloured state to a colourless state to reveal an underlying message or symbol.

The medical device in accordance with the invention may be packaged prior to use in order to seal it from the ambient conditions. The marking may be applied just before the device is sealed into its packaging for sterilisation. The latent marking may be designed to withstand sterilisation of the device following packaging, for example sterilisation by either gamma radiation or ethylene oxide. Removal of the device from its sealed packaging exposes the latent marking to ambient conditions, which triggers the change in the marking.

The latent marking of the present invention may also be adapted so that its visibility changes if the packaging in which the medical device is sealed is disrupted in any way. Exposure of the marking under these conditions would indicate and warn that the device is no longer sterile or suitable for use and should therefore be discarded.

The packaging or packaging materials protects the marking from inadvertent exposure to the ambient conditions that activate the sensitivity of the marking. The packaging may comprise shrink wrap packaging, for example heat shrink wrapping or other suitable packaging which protects the medical device from exposure to ambient conditions. The marking may be so arranged as to become visible upon being irreversibly triggered by exposure to, for example, light or the ambient atmosphere, whether or not that exposure prevails. In the alternative, the marking may become visible over a period of time following and during exposure to, for example, light or the ambient atmosphere. The marking therefore indicates when a device has been removed from its sterile packaging or if the sterile nature of the packaging has been compromised to allow air intake. As a consequence the device may therefore represent a biohazard if used or re-used.

The latent marking of the present invention may therefore be adapted to indicate one or more of the following conditions: the device has been removed from the package and used; the device has been removed from the package, has been used and then re-sterilised; the packaging has been opened and the device exposed to a non-sterile environment for a defined period of time; the packaging has been damaged in transit/storage and the sterility of the device has been compromised, the contents of the device have expired.

Two or more separate latent markings in accordance with the present invention may be provided in relation to the same medical device which are revealed according to different timescales. For example, the medical device may have a latent marking which is designed to develop after a fixed length of time to indicate expiry of the device or its contents, e.g. after a period of one week from initial exposure to ambient conditions. A further latent marking may be provided, for example on the packaging for the device. This marking on the packaging may be designed to develop immediately after it has been exposed to ambient conditions to indicate that the packaging has been disrupted or damaged and its contents are no longer sterile. This dual marking system may therefore provide an indication of both the sterility and expiry date of the device.

According to a second aspect of the invention there is provided a medical device including a latent marking which becomes visible during or following first usage of the device upon removal of sealed packaging materials. Packaging materials as described above are removed from the device prior to first use, which leads to the latent marking becoming visible.

According to a third aspect of the invention there is provided the use of a latent marking system which comprises light or gas sensitive markings, materials, coatings or printing protected by light and/or gas fast packaging in the production of medical devices, including use in the packaging of the device after production. Such packaging may be as described above.

In certain embodiments, the latent marking system may comprise a colourless or invisible marking which upon exposure to ambient conditions (e.g. gases in the air or light) changes to a visible or coloured marking.

In another embodiment, the latent marking system may comprise a visible marking which is obscured by a layer of coloured material. The coloured material may change to form a colourless material following exposure of the layer to ambient conditions, thereby revealing the underlying visible marking. The visible marking may already be present on the device or may be added immediately prior to applying the layer of coloured material.

In another embodiment, the latent marking system may comprise a visible marking which changes colour following exposure to ambient conditions. For example, a green to red colour change may indicate that the device should no longer be used, however any suitable colour change may be employed.

In certain embodiments, the invention relates to the use of light or gas sensitive markings, materials, coatings or printing on disposable items and protection of them with light or gas fast packaging. Prior to opening the light or gas fast packaging, the light or gas sensitive markings, materials, coatings or printing remain invisible and undeveloped. After a period from the time of opening the light or gas sensitive markings, materials, coatings or printing upon exposure to light or a gas change colour to reveal markings such as written or graphic information. The marking can be as informative as need be. Preferably, the light or gas sensitive chemicals used are not toxic in the quantities provided on the marling and to which the user is exposed. Thus, the invention provides a method of producing signs that become visible after exposure to light or gas for a length of time. It also provides a message or graphic information created with the use of light or gas sensitive materials which becomes readable after a period of exposure to light or a gas.

According to a third aspect of the invention there is provided a medical device substantially as hereinbefore described with reference to the accompanying drawings.

Preferred features of the first aspect are for the second and subsequent aspects mutatis mutandis.

It is of course well known to employ chemicals in or on strip material, for example film, for reaction to light or exposure to the ambient atmosphere as is known from photographic technology. It is also known to provide personal admission or attendance badges that upon expiry of the valid time period reveal readable information concerning the time-out or void status of the badge.

Also available are temperature sensitive labels that provide a visual indication as to the temperature level of the items to which they have been applied. For example in washing crockery or other items a label attached to a plate will change colour if the required temperature for sterilisation has been attained. This procedure is of value in hospital catering functions with a view to ensuring a predetermined level of cleanliness and hygiene. In engineering applications labels may be attached to for example casings and if the acceptable temperature level is exceeded the colour of the label changes revealing also the temperature attained.

The present invention, however, is directed to a particular and novel and inventive application of safety marking for single use medical devices.

The present invention embraces any medical device provided with a latent marking howsoever produced of the kind which becomes visible as hereinbefore defmed during or following use.

By way of example one medical device according to the invention is described below with reference to the accompanying drawings in which:

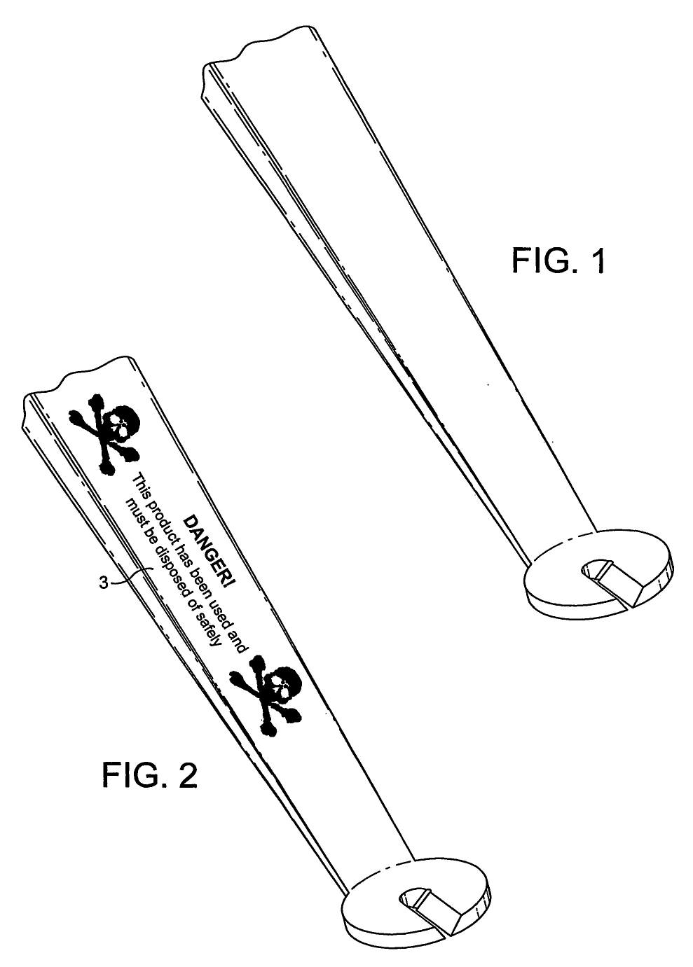

FIG. 1 is an isometric view of the medical device immediately following extraction from its packaging;

FIG. 2 is an isometric view of the medical device after a predetermined period of usage.

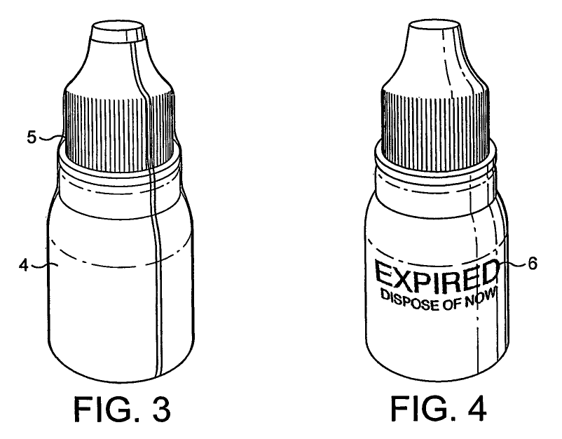

FIG. 3 is an isometric view of a medical container packaged in heat shrink plastic wrapping

FIG. 4 is an isometric view of a medical container following removal of the heat shrink plastic wrapping.

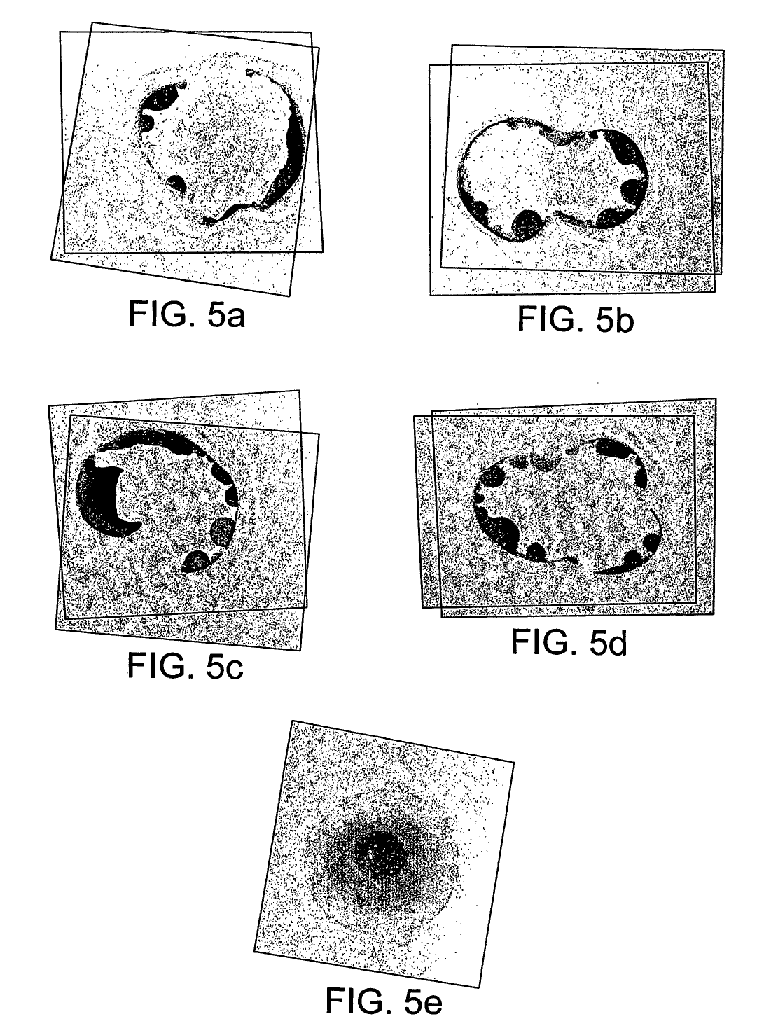

FIGS. 5a to d are photographic pictures of a latent marking prior to full exposure to ambient conditions.

FIG. 5e is a photographic picture of a latent marking following exposure to ambient conditions for four minutes.

Referring to FIG. 1 there is depicted a medical device 1 which in this example is a guide for example for a hypodermic needle (not shown) that provides for an accurate focus and steadiness to reduce patient stress. The device 1 is shown as having been removed from its gas tight packaging ready for use and it will be seen that the surface of the device is clear of any marking.

However the device 1 is provided with a latent marking which remains invisible when the device is packaged and immediately following unwrapping. However, once the device 1 is exposed to the ambient conditions, either light or gas, e.g. air, the latent marking 2 begins to appear and after a set period of time becomes completely visible to reveal a warning as illustrated by way of example only in FIG. 2.

As will be seen, the marking 2 conveys the message that the device has been used and should be disposed of safely and draws attention to itself by being flanked by the skull and crossbones symbols warning of danger. It is of course to be understood that the message may be couched in different words but that it conveys the same intent, namely to warn for example that the device should be destroyed or professionally re-sterilised having already been used. It also serves as a reminder to the actual user that it should be discarded following completion of the relevant procedure.

The latent marking 2 may be gas, light or heat sensitive. Conveniently the disclosure of the latent marking by such exposure may be irreversibly triggered thereby in order to prevent any steps subsequently being taken to negate or arrest the process.

The latent marking 2 may either be etched into the surface of the device or be in the form of a label irremovably adhered to that surface or a dye or chemical as defined above applied directly to the device. A protective seal may be provided over the marling to prevent tampering and protect against inadvertent damage or premature activation. The seal may be a film.

The latent marling 2 may be applied in the form of selected dyes chosen for the characteristic of being invisible in one medium and visible upon exposure to gas, light or heat in another medium. In the alternative, the latent marking may include chemicals which upon exposure become visible as indicated above. Alternatively, the latent marking may include a coloured layer which upon exposure changes to colourless to reveal an underlying visible marking.

Referring to FIG. 3 there is depicted a medical device comprising a container for a pharmaceutical preparation, which in this example is an eye drop dispenser. The container 4 is shown unopened and sealed in gas tight shrink wrapping 5.

The container 4 is provided with a latent marking 6 which remains invisible when the device is packaged and immediately following unwrapping. However, once the container 4 is exposed to the ambient conditions e.g. air by removal of the gas tight packaging, the latent marking 6 begins to appear and after a set period of time becomes completely visible to reveal a warning as illustrated by way of example only in FIG. 4.

As will be seen, the marking 6 conveys the message that the contents of the container i.e. the eye drop preparation have expired and should be disposed of safely.

The latent marking 2 may be gas or light sensitive. Suitable latent markings are described above.

The latent marking 2 may either be provided on the surface of the device or be in the form of a label irremovably adhered to that surface. In either or both cases a protective seal may be provided over the marking to prevent tampering and protect against inadvertent damage or premature activation. The seal may be a film.

Although the container shown in FIGS. 3 and 4 is unmarked, other than for the presence of the latent marking following its appearance, an eye drop bottle or other container in accordance with the invention may contain a label or printing applied directly to the bottle having instructions for use, manufacturers information, safety instructions and other information important for the end user or dispenser (e.g. pharmacy, doctor or other medical professional). The latent marking may therefore initially comprise an invisible marking in order to enable users to clearly read the contents of the manufacturers label. The marking may however develop following removal of the external packaging and exposure to ambient conditions into a visible opaque or coloured form which covers or obliterates some of the information already provided in order to provide a clear message or indication of the expiry of the contents.

FIGS. 5a, 5b, 5c and 5d show an example of a latent marking in according with the present invention. The oxygen activated Vat dye represented by the lighter coloured or colourless portions is sandwiched between two layers of clear Melinex polycarbonate plastic. The darker or opaque portions represent areas at the edge of the sandwich which have been exposed to air, thereby inducing the resultant colour change.

FIG. 5e shows a photograph of the latent marking of FIGS. 5a to d taken four minutes after the top layer of plastic was removed to expose the Vat dye to ambient conditions. The light coloured or colourless dye has changed to a dark opaque form over its whole area due to oxidation following exposure to the air.

The latent marking of FIGS. 5a to e may therefore be applied to a medical device as defined above.

The present invention thus provides for the security of medical devices by giving both a visual indication as to their usage and a warning that they should be discarded in the interests of patient safety. Further the invention represents a relatively simple and yet effective manner of indicating that the use of the device is no longer valid and would compromise the clinical condition or the safety of the patient.

1-12. (canceled)

13. A medical device sealed in gas tight packaging, wherein the medical device comprises a latent marking comprising an oxidisable dye which becomes visible after a predetermined time following exposure of the device to air and further comprising a reducing agent, wherein prior to the opening of the packaging the marking remains invisible and undeveloped and wherein after a period of time from the opening of the packaging the marking becomes visible.

14. A medical device according to claim 13 in which the latent marking is etched into the surface of the device and the marking is obscured by an opaque layer prior to exposure of the device to air, wherein the opaque layer changes to clear or colourless following exposure of the device to air.

15. A medical device according to claim 13 in which the latent marking is carried on a label irremovably adhered to the surface of the device.

16. A medical device according to claim 15 in which the latent marking comprises dyes or chemicals applied in such manner to yield a warning message in the visible spectrum following exposure.

17. A method of informing an individual of the use status of a medical device within gas tight packaging comprising including a latent marking on the medical device, wherein the latent marking comprises an oxidisable dye and a reducing agent, wherein the oxidisable dye becomes visible after a predetermined time following exposure of the medical device within the gas tight packaging to air, and wherein prior to the opening of the packaging the marking remains invisible and undeveloped, and wherein after a period of time from the opening of the packaging the marking becomes visible.

18. A method according to claim 17 wherein the latent marking is etched into the surface of the medical device and the marking is obscured by an opaque layer prior to exposure of the device to air, wherein the opaque layer changes to clear or colourless following exposure of the device to air.

19. A method according to claim 17 in which the latent marking is carried on a label irremovably adhered to the surface of the device.

20. A method according to claim 19 in which the latent marking comprises dyes or chemicals applied in such manner to yield a warning message in the visible spectrum following exposure.
